(19) United States
(12) Patent Application Publication
(10) Pub. No.: US 2018/0217034 A1
(43) Pub. Date: Aug. 2, 2018

(54) COILED WIRE SAMPLER

(71) Applicant: PerkinElmer Health Sciences, Inc., Waltham, MA (US)

(72) Inventors: Edgar Lee, Wallsburg, UT (US); Tai Van Truong, Taylorsville, UT (US); Ben Black, West Valley City, UT (US); Milton Lee, Pleasant Grove, UT (US)

(21) Appl. No.: 15/885,674

(22) Filed: Jan. 31, 2018

Related U.S. Application Data
(60) Provisional application No. 62/452,691, filed on Jan. 31, 2017.

(51) Int. Cl. G01N 1/40; G01N 30/16; G01N 1/14

(52) U.S. Cl. CPC G01N 1/405; G01N 2001/1427; G01N 1/14; G01N 30/16

(57) ABSTRACT

A rugged SPME system and method for up-taking analytes, allowing injection of liquid samples in the field, providing better quantitation and reproducibility, and having higher capacity than other SPME devices that use a fiber, wherein the embodiments include a SPME stainless steel coiled wire sampler that may wick a liquid sample into the coil to thereby deliver a consistent quantity of liquid to an analyzer.

### BACKGROUND OF THE INVENTION

### Field of the Invention

This invention relates generally to a Solid Phase Micro-extraction (SPME) device that may be used to collect samples for analysis. More specifically, the SPME device includes a coiled wire sampler that may be more effective for handling liquid, especially in a field application.

### Description of Related Art

The technique of solid phase micro extraction (SPME) was introduced in the 1990s and has become a popular and widely used equilibrium-based solvent-less sampling method for GC and GC-MS that is fast, economical and versatile. SPME is known to those skilled in the art as a technique for sampling and concentrating chemical compounds for analysis.

In the prior art method of SPME, it uses a fiber that may be coated with a polymer, a solid (sorbent), or a combination of both. The fiber coating extracts the compounds from a sample by absorption in the case of liquid coatings or absorption in the case of solid coatings. The SPME fiber is then inserted directly into a chromatograph for desorption and analysis. However, the quantity of liquid that may be sampled using a fiber in a field environment may be far too small for proper analysis to be performed.

It should be understood that when discussing polymers, PDMS has served as an extracting polymer for numerous other equilibrium-based sampling techniques due to its inertness and predictable advantages. For example, thin PDMS films have been coated inside GC columns; thick PDMS films have been coated on stir bars for sorptive extraction (SBSE) and in capillary tubes for open tubular trapping (OTT); and PDMS particles have been used in extraction cartridges for sampling.

Typically, an SPME fiber is used to extract analytes from a sample and deliver them for analysis. The fiber may typically be made of a fused silica or a metal which is then coated with a polymer or an absorbent that is used to capture and concentrate the analytes by partition or adsorption. The fiber may be moved to a sample introduction port of a chromatograph or spectrometer for desorption or extraction for analysis.

The fiber used for SPME may typically be held in the bore of needle that is part of a syringe-like device for convenience. The fiber may be protected and moved within the walls of a protective sheath of the needle that extends outwardly from the syringe-like device.

Use of a sample analyzer away from a desktop or laboratory setting may be more difficult to use because of the nature of the sampling tools and the size of the sample that may be introduced into the analyzer. For example, the Torion T-9 Portable GC/MS is a field-capable analyzer that is ideal for rapid screening of chemicals, including environmental volatiles and semi-volatiles (VOCs/SVOCs), explosives, chemical warfare agents, hazardous substances, and for use in food safety and industrial applications. While the T9 analyzer has proven to be a reliable unit, the size of the sample must be considered.

Unfortunately, it has generally been the case that handling liquids and performing liquid injections for GC/MS analysis is impractical in the field because it is too difficult to deliver a consistent and small quantity of liquid to the GC/MS analyzer. Furthermore, SPME fibers may also have poor up-take of high boiling compounds. Therefore, field analysis of liquids has been a problem.

While an SPME fiber is a poor instrument to use for liquids, the alternatives have not been better. This is because the quantity of liquids being delivered is so small that it is difficult to consistently measure these small amounts, thus resulting in inconsistent results from the GC/MS analyzer. For example, the amount of liquid that should be delivered to a portable GC/MS analyzer may be as small as 0.5 microliters.

Accordingly, it would be an advantage over the prior art to have a SPME sampler that could deliver a consistent sample size for a portable analyzer, whether that sample is a liquid or a solid. It would be a further advantage to provide an SPME sampler that may deliver a consistent quantity of a liquid from an SPME sampler that would not overwhelm the portable analyzer. Finally, it would be an advantage to provide a robust SPME sampler that is suitable for field use.

### BRIEF SUMMARY OF THE INVENTION

In a first embodiment, the present invention is a rugged SPME system and method for up-taking analytes, allowing injection of liquid samples in the field, providing better quantitation and reproducibility, and having higher capacity than other SPME samplers that use a fiber, wherein the embodiments include a SPME stainless steel coiled wire sampler that may wick a liquid sample into the coil to thereby deliver a consistent quantity of a liquid to an analyzer.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective view of a syringe-like device or actuator device that contains a coiled wire sampler of the first embodiment of the invention.

FIG. 2 is a perspective and exploded view of the components within the actuator device shown in FIG. 1.

FIG. 3 is a profile view of the first embodiment of the invention wherein a coiled wire is fully retracted within a body of a protective sleeve.

FIG. 4 is a profile view of the first embodiment of the invention wherein the coiled wire is fully extended from the protective sleeve.

FIG. 5A is a cut-away profile of the first embodiment of the invention as shown in FIG. 4.

FIG. 5B is a close-up profile view of a portion of the first embodiment as shown in FIG. 5A.

FIG. 6 is a perspective and close-up view of the coiled wire that is disposed in the first embodiment.

FIG. 7 is a profile and close-up view of the coiled wire with a crimping end for attachment to the coiled wire plunger.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention and should not be viewed as narrowing the claims which follow.

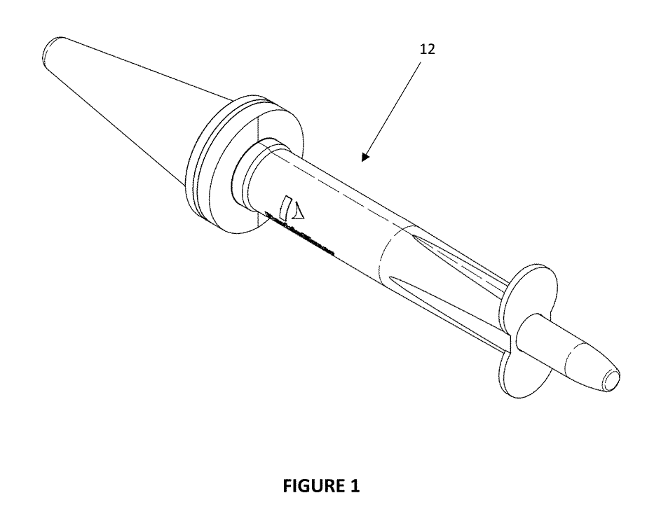

The first embodiment of the present invention is shown in FIG. 1. FIG. 1 is a perspective view of an actuator device 12 that functions as a hand grip and as a housing for a coiled wire sampler (not shown) of the first embodiment of the invention.

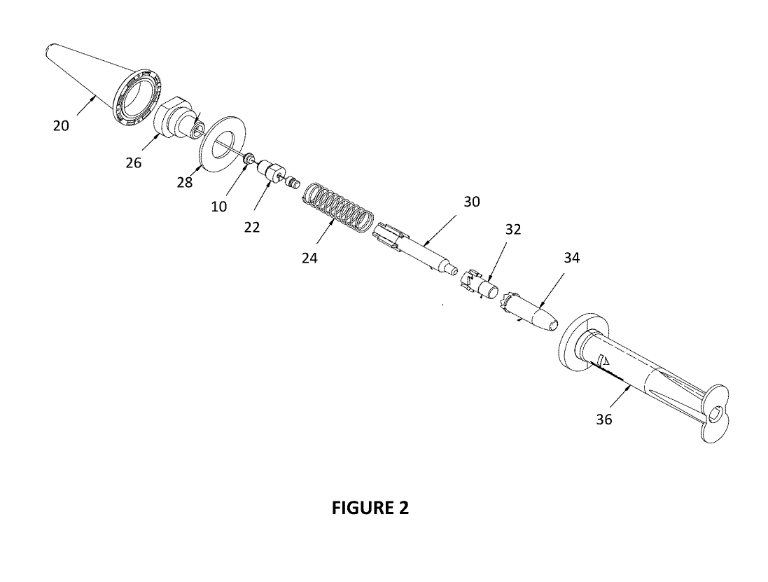

FIG. 2 is a perspective and exploded view of the components within the n device 12 shown in FIG. 1. While these components are part of the first embodiment, it should be understood that the coiled wire sampler may be disposed within any actuator device that may be used to hold the coiled wire sampler when it is taking a sample, transporting a sample and delivering a sample, and is not limited to the actuator device 12 shown.

The actuator device 12 in the first embodiment may include a cap 20, a clamp 22, an internal spring custodian 24, an SPME adapter 26, the coiled wire sampler 10, an SPME board 28, an actuator plunger 30, a plunger assembly actuator cam 32, a thumb slide 34, and an actuator body 36.

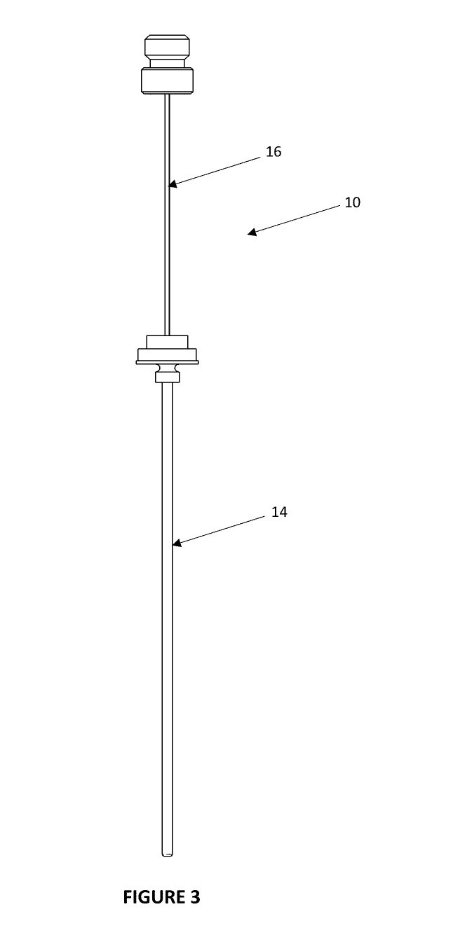

FIG. 3 is a profile view of the first embodiment of the invention wherein a coiled wire (not shown) is fully retracted within a needle or sleeve 14. A coiled wire plunger 16 is shown retracted so that the coiled wire is fully retracted and protected within the sleeve 14. The coiled wire plunger 16 is coupled to the coiled wire sampler as will be shown.

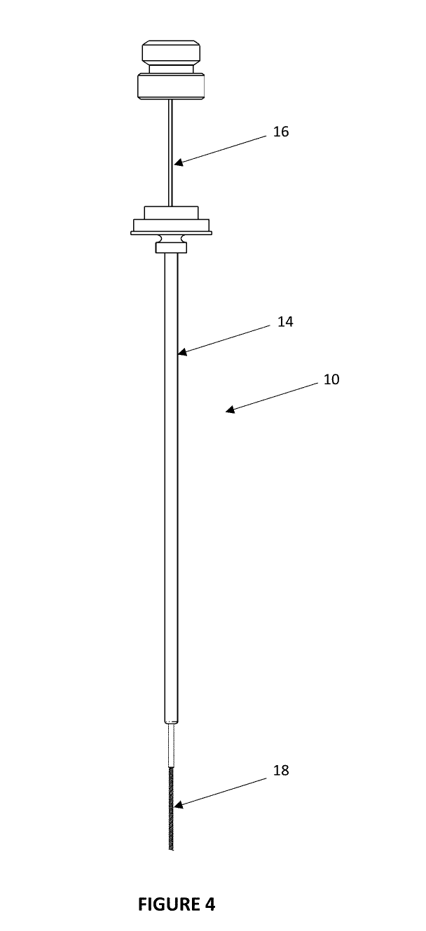

FIG. 4 is a profile view of the first embodiment of the invention wherein is shown the coiled wire sampler 10 having the coiled wire plunger 16 pushed down into the protective sleeve 14 to extend the coiled wire 18.

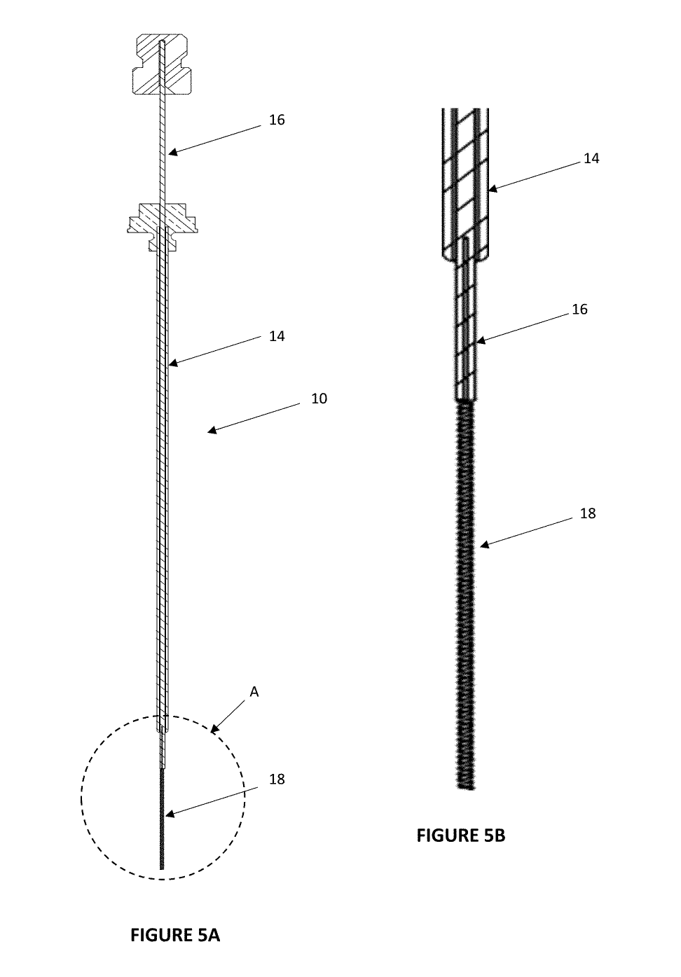

FIG. 5A is a cut-away profile of the first embodiment of the invention as shown in FIG. 4 wherein is shown the coiled wire sampler 10 having the coiled wire plunger 16 pushed down into the protective sleeve 14 to extend the coiled wire 18. A portion of the coiled wire sampler 10 is shown within circle A.

FIG. 5B is a close-up profile view of a portion of the first embodiment as shown in FIG. 5A that is within the circle A. What is shown is that the coiled wire plunger 16 is also extended from the end of the sleeve 14. The coiled wire 18 is shown coupled to an end of the coiled wire plunger 16 where they overlap.

While the first embodiment shows that the coiled wire plunger 16 extends from the sleeve 14, this feature is not required, and should not be considered a limiting aspect of the invention.

The sleeve 14 may be selected from any material that provides the desired protection of the coiled wire 18 and a sample. For example, the sleeve 14 may be a needle having a bore of sufficient size to enable ejection and retraction of the coiled wire 18.

A connection between the coiled wire plunger 16 and the coiled wire 18 may be made in any convenient manner. For example, the coiled wire 18 may be inserted into the end of the coiled wire plunger 16, or some attachment mechanism may be disposed from one to another such as a crimping overlay. In this first embodiment, the coiled wire 18 is disposed into an end of the coiled wire plunger 16 to form a friction fit.

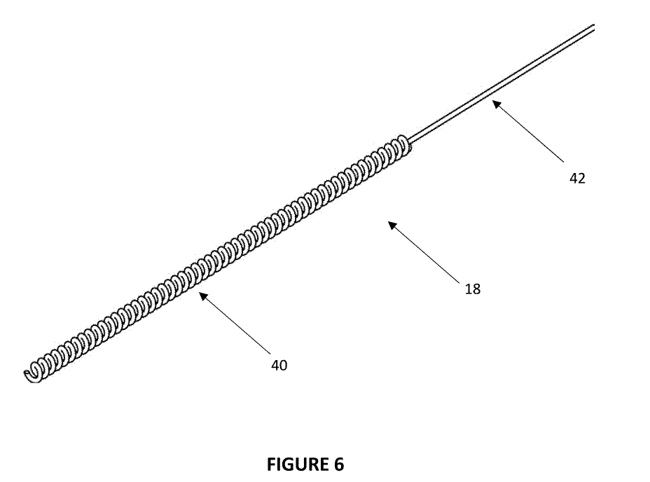

FIG. 6 is a perspective and close-up view of the coiled wire 18 that is used in the first embodiment. The coiled wire 18 may include a working end 40 and an attaching end 42.

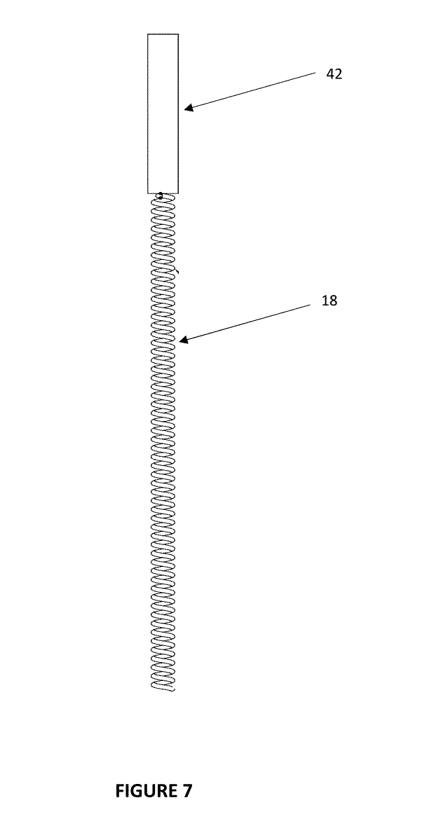

FIG. 7 is a profile and close-up view of an alternative embodiment of the coiled wire 18 having a flat surface on the attaching end 42 for attachment to the coiled wire plunger 16.

The first embodiment of the present invention has several advantages over the prior art. While the advantages apply specifically to use with a portable GC/MS, the first embodiment may be used with any type of analyzer.

First, the coils of the coiled wire 18 are selected to be of a particular size so that when the coiled wire 18 is introduced to a liquid sample, capillary action or wicking will cause a liquid to flow into the coiled wire without the assistance of, or even in opposition to, external forces such as gravity. However, it should be understood that the size may vary and is not limited to a single diameter but may also be a function of other factors. Nevertheless, if the diameter of the coiled wire 18 is sufficiently small, then a combination of surface tension and adhesive forces between the liquid and the coiled wire 18 may act to propel the liquid all the way until the end of the coiled wire. In this first embodiment, the coiled wire 18 ends where the attachment end 42 meets the working end 40.

The length of the coiled wire 18 has been selected to be approximately 10 mm in length. The diameter of the coiled wire 18 has been selected to be approximately 0.36 mm. However, the dimensions of the first embodiment of the invention should not be considered limited to this selected length and diameter of the coiled wire 18. These dimensions are for illustration purposes only and may be altered and still fall within the scope of the invention.

Another aspect of the invention is the amount of liquid that is capable of being stored within the coiled wire 18 of the coiled wire sampler 10. The selected length and width of the coiled wire 18 described above may result in the collection of 0.5 microliters of a liquid, so long as there is sufficient liquid to fill the coiled wire 18. The 0.5 microliter capacity of the coiled wire sampler was selected specifically for a portable GC/MS analyzer such that the volume of the liquid in a sample will not overwhelm the analyzer with too much liquid.

It is a substantial advantage over the prior art to provide a SPME sampler that does not rely on visually determining if such a small amount of liquid has been drawn into the sampler. So long as there is sufficient liquid, the same amount of liquid may be drawn into the coiled wire sampler 10 every time that it is used. Accordingly, the first embodiment provides a precision tool for gathering an amount of liquid that will not overwhelm the smaller sampling capacity of a portable analyzer. The result is better quantitation and reproducibility. Furthermore, the coiled wire sampler 10 provides a liquid sample that does not require visual confirmation and yet provides a larger quantity of liquid than the fiber of an SPME.

Another aspect of the first embodiment is the material used for creating the coiled wire 18. A first material selected was an inert material such as platinum. Platinum was selected for the coiled wire 18 because it is generally a non-reactive material that will not contaminate or compromise the sample. However, it was determined through experimentation that platinum was too soft of a material for commercial applications and was therefore easily damaged. Accordingly, it was determined that it would be better to select a harder material for the coiled wire 18 which could then be coated with a deactivation material.

The first embodiment thus may include stainless steel as a material for the coiled wire 18 because it is substantially more durable than platinum. However, it should be understood that any other material may be used as long as it is sufficiently durable and may be coated with a deactivation material that prohibits interaction with the compounds being sampled by the coiled wire sampler 10.

The deactivation material that is used to coat the coiled wire 18 may be selected from any deactivation materials that render the coiled wire 18 inert. It is noted that the coating process used in the first embodiment is a proprietary coating material and process that is provided by a third party. What is important is that a deactivation material such as SULFINERT™ may be obtained from some third party in order to provide the desired coating.

It is also noted that some deactivation coatings may include other properties. For example, the deactivation coating may include a polymer that enables the selective capture of analytes.

In addition, it is understood that the deactivation coating on the coiled wire 18 may be further coated with another coating, such as a polymer, to achieve a desired effect of obtaining a more selective capture of analytes. Thus, layers of coatings may provide deactivation with the coiled wire 18, as well as selective capture of analytes.

It should also be understood that a coating on the coiled wire 18 may not be a polymer but may be another material. For example, the coating may be a metallic material, silica, silicone, or any other desired material that may assist in the selection and collection of a particular analyte.

The coiled wire sampler of the first embodiment may provide sample collection, preparation and injection into an analyzer such as a GC or GC/MS. However, the coiled wire sampler should not be considered as limited to these areas, and may find use in MS, MS/MS, ICPMS, TGA, and other analyzers.

The embodiments of the invention may be faster at the up-taking of analytes, may allow the injection of liquid samples in the field and provide better quantitation and reproducibility in a rugged system that may have higher capacity than other SPME systems. The first embodiment may be especially useful for rapidly gathering samples of high-boiling compounds.

The first embodiment of the present invention may be useful for the collection of high-boiling semi-volatile organic compounds, volatile organic compounds, as well as inorganic materials.

It should be understood that while the first embodiment of the coiled wire sampler described above is useful for liquids, it may also be used for sampling solids and has no limitations in this regard, and therefore may be a substitute for an SPME that uses a fiber and provide capabilities beyond the fiber.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A Solid Phase Micro-extraction (SPME) coiled wire sampler that is used to sample, transport and deliver a sample to an analyzer, said SPME sampling device comprised of:
a coiled wire formed along a long axis thereof and having a working end and an attaching end;
a coiled wire plunger coupled to the attaching end of the coiled wire and disposed so as to be co-axial with the long axis of the coiled wire; and
a sleeve forming a tube and disposed around the coiled wire and the coiled wire plunger, wherein the coiled wire and the coiled wire plunger are free to move within the sleeve along a length thereof.

2. The SPME coiled wire sampler as defined in claim 1 wherein the coiled wire is comprised of a metal.

3. The SPME coiled wire sampler as defined in claim 2 wherein the coiled wire is further comprised of stainless steel.

4. The SPME coiled wire sampler as defined in claim 1 wherein the coiled wire is further comprised of a deactivating coating material that is disposed on the coiled wire, wherein the deactivating coating material makes the coiled wire substantially inert to the sample.

5. The SPME coiled wire sampler as defined in claim 4 wherein the deactivating coating material is further comprised of a second coating disposed on top of the deactivating coating material, wherein the second coating provides selective capture of analytes from the sample.

6. The SPME coiled wire sampler as defined in claim 4 wherein the second coating is selected from a polymer, a metal, silica or silicone.

7. The SPME coiled wire sampler as defined in claim 1 wherein the coiled wire is further comprised of a diameter of the coiled wire being sufficiently small to cause capillary uptake of a liquid sample.

8. The SPME coiled wire sampler as defined in claim 1 wherein the coiled wire is further comprised of a deactivating coating material and a polymer that is disposed on the coiled wire, wherein the deactivating coating material makes the coiled wire substantially inert to the sample and the polymer provides selective capture of analytes from the sample.

9. The SPME coiled wire sampler as defined in claim 1 wherein the SPME coiled wire sampler is further comprised of an actuator, wherein the SPME coiled wire sampler is disposed within the actuator, wherein manipulation of the actuator causes an actuator plunger to push the coiled wire plunger which pushes the coiled wire from the sleeve.

10. A method for using a Solid Phase Micro-extraction (SPME) coiled wire sampler to sample a liquid compound, said method comprising:
providing a coiled wire formed along a long axis thereof and having a working end and an attaching end, a coiled wire plunger coupled to the attaching end of the coiled wire and being co-axial with the long axis of the coiled wire, and a sleeve forming a tube and disposed around the length of the coiled wire and the coiled wire plunger, wherein the coiled wire and the coiled wire plunger are free to move within the sleeve along a length thereof, wherein the coiled wire is disposed within the sleeve when no force is applied to the coiled wire plunger;
applying a force to the coiled wire plunger while holding the sleeve to thereby eject the coiled wire from the sleeve for the sample to be taken; and
releasing the force from the coiled wire plunger to thereby retract the coiled wire and the sample inside the sleeve.

11. The method as defined in claim 10 wherein the method further comprises:
providing an actuator for housing and holding the SPME coiled wire sampler, and providing an actuator plunger that is in contact with the coiled wire plunger;
applying a force to the actuator plunger which applies a force to the coiled wire plunger to thereby eject the coiled wire from the sleeve for the sample to be taken; and
releasing the force from the actuator plunger to thereby retract the coiled wire and the sample inside the sleeve within the actuator.

12. The method as defined in claim 10 wherein the method further comprises using capillary action of the coiled wire to draw a liquid sample into the coiled wire.

13. The method as defined in claim 12 wherein the method further comprises always drawing substantially the same amount of liquid into the coiled wire to thereby obtain a reproducible amount of the liquid sample each time.

14. The method as defined in claim 13 wherein the method further comprises not having to visually confirm the amount of the liquid sample.

15. The method as defined in claim 10 wherein the method further comprises providing a metal as the coiled wire.

16. The method as defined in claim 10 wherein the method further comprises selecting the metal of the coiled wire to be stainless steel.

17. The method as defined in claim 10 wherein the method further comprises disposing a deactivating coating material on the coiled wire, wherein the deactivating coating material makes the coiled wire substantially inert to the sample.

18. The method as defined in claim 17 wherein the method further comprises disposing a deactivating coating material and a polymer on the coiled wire, wherein the deactivating coating material makes the coiled wire substantially inert to the sample and the polymer provides selective capture of analytes from the sample.

19. The method as defined in claim 17 wherein the method further comprises disposing a second coating on top of the deactivating coating material, wherein the second coating provides selective capture of analytes from the sample.

20. The method as defined in claim 17 wherein the method further comprises selecting the second coating from a polymer, a metal, silica or silicone.
